(19) United States
(12) Patent Application Publication
(10) Pub. No.: US 2020/0274830 A1
(43) Pub. Date: Aug. 27, 2020

(54) INTEGER CONVERSION FOR LOCALLY STORED DATA IN PRIORITY QUEUES

(71) Applicant: 55 Global, Inc., New York, NY (US)

(72) Inventors: Ashu Swami, Freehold, NJ (US); Maodong Xu, Mill Neck, NJ (US)

(21) Appl. No.: 16/508,194

(22) Filed: Jul. 10, 2019

Related U.S. Application Data
(60) Provisional application No. 62/810,910, filed on Feb. 26, 2019.

(51) Int. Cl. H04L 12/861; G06F 7/483; H04L 29/06

(52) U.S. Cl. CPC H04L 49/90; H04L 69/16; G06F 7/483

(57) ABSTRACT

A feed handler is configured to receive a transaction entry from a data feed, the transaction entry indicating at least a floating-point value amount, the data feed associated with a transaction target. The feed handler modifies a locally stored priority queue based on the transaction entry by converting the floating-point value amount in transaction entry to an integer value amount based on a ratio between two underlying components indicated by the transaction target; and storing the integer value amount in a corresponding entry in the locally stored priority queue.

### CROSS-REFERENCE TO RELATED APPLICATION

The present application claims the benefit of U.S. Provisional Patent Application No. 62/810,910, filed on Feb. 26, 2019, which is hereby incorporated by reference in its entirety.

### TECHNICAL FIELD

The disclosure generally relates to data processing optimization and compression, and in particular to integer conversion for locally stored data in priority queues.

### BACKGROUND

In some networked systems, a first computing device (e.g., a feed handler server) may receive a data feed from a second computing device (e.g., a remote server). This data feed may include multiple entries which include data regarding information that is continuously updated. Upon update of the information, the data feed generates a new entry or element which is transmitted to the first computing device. Upon receipt of the new data feed entry, the first computing device may process the data contained in the new data feed entry and store it locally in a local database. Furthermore, the first computing device may provide information contained in this local database to various client devices, for use by one or more users. In some cases, any data received from the data feed should be provided to the client devices with a delay that is as small as possible. However, this can be difficult to achieve when the size of the data received is large and when the rate at which the data is received is high. Therefore, what is lacking is a method of achieving more optimal data compression at the local database of the data received from the data feed in order to reduce the delay in the processing of the data feed updates and to reduce resource usage during the processing.

### SUMMARY

Embodiments relate to a feed handler configured to receive a transaction entry from a data feed. The transaction entry indicates at least a floating-point value amount, and the data feed is associated with a transaction target. The feed handler modifies a locally stored priority queue based on the transaction entry by converting the floating-point value amount in the transaction entry to an integer value amount based on a ratio between two underlying components indicated by the transaction target. The feed handler stores the integer value amount in a corresponding entry in the locally stored priority queue.

### BRIEF DESCRIPTION OF THE DRAWINGS

Figure (FIG. 1 illustrates an example system comprising a data feed and feed handler server, in accordance with an embodiment.

FIG. 2 is a block diagram illustrating the components the feed handler server of FIG. 1, in accordance with an embodiment.

FIG. 3 is a block diagram illustrating an example of an optimized computer data structure in which the data feed entries from remote data feed are stored, in accordance with an embodiment.

FIG. 4 is a block and flow diagram illustrating an example conversion of data received from the data feed to increase data compression, in accordance with an embodiment.

FIG. 5 is a flowchart illustrating an example process for data compression of data received from a remote data feed, in accordance with an embodiment.

FIG. 6A is a block diagram illustrating a chain of transactions recorded on a blockchain that may be utilized in the system described in FIG. 1, in accordance with an embodiment.

FIG. 6B is a block diagram illustrating a connection of multiple blocks in a blockchain that may be utilized in the system described in FIG. 1, in accordance with an embodiment.

FIG. 7 is a block diagram illustrating an example computing device, in accordance with an embodiment.

The figures depict, and the detail description describes, various non-limiting embodiments for purposes of illustration only.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

FIG. 1 illustrates an example system 100 comprising a data feed and feed handler server, in accordance with an embodiment. System 100 includes a network 110, one or more client devices 120 (referred to as client devices 120 or a client device 120), a remote data feed server 135, one or more remote data source server 135, and a feed handler server 140. In various embodiments, the system 100 may include different, fewer, or additional components. The components in the system 100 may each correspond to a separate and independent entity or may be controlled by the same entity.

The communications among the elements in the system 100 may be transmitted via the network 110, which may be, for example the Internet, a local area network, and so on. Some of the elements may communicate by one network, while other elements may communicate using a separate network. Each of these separate networks may be similar to the network 110. In one embodiment, the network 110 uses standard communications technologies and/or protocols. Thus, the network 110 can include links using technologies such as Ethernet, 702.11, direct microwave point to point connections, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 110 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the elements in the system 110 can use custom and/or dedicated data communications technologies instead of, or in addition to, the ones described above. For example, the network 110 may use a lean TCP/IP protocol that avoids a TCP/IP handshake penalty between elements to reduce communications latency.

The one or more client devices 120 are computing devices that may be operated by a user and be used by the user as a front-end device with which the user may be able to access data at the feed handler server 140. The client devices 110 may be any computing devices. Examples of client devices 110 include personal computers (PC), desktop computers, laptop computers, tablet computers, smartphone, wearable electronic devices such as smartwatches, or any other suitable electronic devices.

The user devices 110 may each include an interface 125, which may be provided by the feed handler server 140 or by computer-readable instructions executed by the client device 120. The user may be able to access data or available at the feed handler server 140 via the interface 125. In addition, the user may also be able to submit transaction requests via the interface 125. The interface 125 may take different forms. In one embodiment, the interface 125 is a component of a software application, which may be provided by the feed handler server 140. For example, the software application may provide a front-end user interface that can be provided at the client device 120. The software application may be a package of computer-executable code that can be acquired (e.g., downloaded) and installed or executed at a client device 120. In another embodiment, the interface 125 may be an interface provided directly via the feed handler server 140 or other server. For example, the interface 125 may be one or more web pages. The interface 125 may include a graphical user interface (GUI) that displays various information and graphical elements. In another embodiment, the interface 125 may not include graphical elements but may communicate with the feed handler server 140 via other suitable ways such as application program interfaces (APIs).

The remote data feed servers 130 (referred to herein as remote data feed servers 130 or remote data feed server 130) may be one or more computing systems that each provide one or more data feeds 131 (referred to herein as data feeds 131 or collectively as data feed 131) to the feed handler server 140. The data feed 131 includes continuously updated information regarding a particular data source or data sources, such as the remote data source servers 135. The data sources may contain information regarding some of the elements being described in the data feed 131, such as transactions (e.g., orders made in a financial market, purchase orders at a retail organization, logistics updates, shipping information), news (e.g., breaking news), predictions (e.g., weather reports), current statuses (e.g., status of equipment, public transportation, satellite positions), and so on. The data feed 131 may be provided using various data formats, such as CSV (comma separated value), XML (extensible markup language), and so on. The data feed may be provided using a custom format, such as with an expanded character set or the use of binary characters, and the data within may be encrypted prior to transmission.

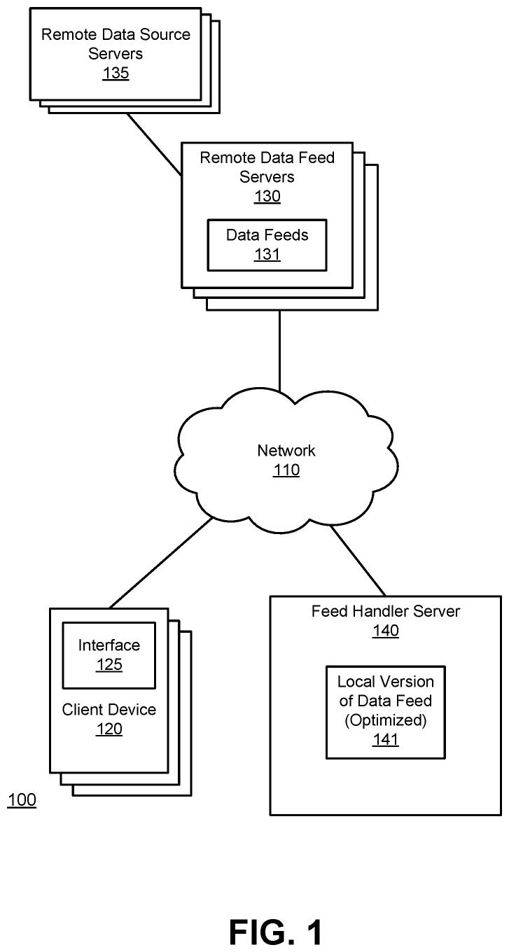

The data feed 131, when provided, may be transmitted in one or more updates. Each update may occur as the data is generated, or may be generated periodically. For example, in the case of transactions, an entry in the data feed 131 may be provided for each new transaction that is detected, generated, recorded, etc. Each update may have information about the data feed 131 itself (e.g., an identifier), as well as information about the element being described. For example, in the case of transactions, the corresponding data feed entry may include information about the type of transaction, a value amount, timestamp of transaction, and so on. By receiving the data feed updates, a recipient computing device, such as the feed handler server 140, may be able to determine a current state of the elements being described in the data feed 131. For example, where the data feed 131 includes information about transactions, the receipt of the data feed 131 allows a system to determine a complete state of the transactions described by the data feed, i.e., to determine the current state of the market/exchange comprising these transactions. Additional details regarding the format of the data feed 131 will be described below with reference to FIGS. 2-5.

The feed handler server 140, which includes one or more computing systems, receives updates from the data feed 131 and generates a local version 141 of the information in the data feed 131. The feed handler server 140 may process the data feed 131 using methods that reduce the processing time needed to process the updates to the data feed 131 and by reducing the resource requirements used to store the local version 141. In one embodiment, in order to reduce processing times, the feed handler server 140 may use a lean TCP/IP protocol, using a custom networking hardware, in order to receive the data feed 131 from the remote data feed server 130. The feed handler server 140 may also use direct memory access to store the received data feed 131 after it is received.

In addition, the feed handler server 140, when storing the local version 141 of the information in the data feed 131, may use optimal data structures for the local version 141 and use optimized processes to convert the data from the data feed 131 into the local version 141. In one embodiment, the local version 141 may comprise multiple priority queues, which store updates from the data feed 131 by priority according to the time at which the update was received (or by the timestamp within the data feed entry in the update) and may store the data further in accordance with some other information within each update, such as a value amount indicated in each data feed entry of the update.

Furthermore, the feed handler server 140 may compress the data from the data feed updates in order to reduce the size that the data occupies within the memory of the feed handler server 140. In particular, in some cases the data feed 131 includes entries that have floating point or decimal values that occupy a large memory footprint, and the memory allocated for these values have to accommodate a large range of changes for these values. These numbers may represent ratios between two values for which the data feed 131 entry includes information about. For example, the value may indicate a ratio between a total amount of greenhouse gas emissions and a change in global temperatures. As another example, the value may indicate a ratio between two different currencies (i.e., a price or cost to purchase one currency using another currency). In many of these cases, the ratio may be a very large or very small number due to the large differences in magnitude between the two values being compared. Continuing with the previous example, a large amount of greenhouse gases may be emitted for a small change in temperature to occur. As another example, the exchange rate between two currencies may be very large as one unit of one currency may be exchanged for a very large number of another currency. Furthermore, in some cases these ratios may change in scale dramatically over time. For example, the exchange rate between two currencies may fluctuate wildly due to instabilities in the market. As another example, a ratio between device counts on a network and total network usage may change dramatically over time depending on spikes in network usage.

Therefore, in order to store these values, the local version 141 may have to allocate significant memory space to store each of these values, as they may be very large or small numbers, but also because they may change in scale across many orders of magnitude. This usage of resources is not necessarily optimal, as it may cause the memory size of the local version 141 to exceed the available memory, especially in the case where the data feed 131 is very frequently updated.

Instead, to avoid these issues, the values can be modified in order to reduce their space used while still preserving the accuracy of the data in the values. As described in further detail below with regard to FIGS. 2-5, the feed handler server 140, modifies (i.e., shrinks or compresses) these values by modifying the values with an exponent value that is derived from the differences between the two components that make up the ratio indicated by the value. Continuing from the previous example, an exponent value may be computed based on the ratio between the two currencies that are used to generate the currency exchange ratio value. This exponent may be used to modify the currency exchange value in order to reduce its size, while still preserving the proper transaction resolution in the form of the tick size.

Using the combination of optimizing resource usage and modification of received data, the load processing server 140 can reduce the latency and resourced needed to process the updates from the data feed 131 and have these updates reflected in the local version 141. Although the description above has been made primarily with regards to a single data feed 131, in some cases the feed handler server 140 may process updates from multiple data feeds 131 from multiple sources (e.g., multiple venues), and combine the data feed entries from these multiple data feeds into the local version 141 to form a combined or aggregated version of all the data feeds 131 at the local version 141. This allows a user accessing the local version 141 to be able to view data from multiple data feeds 131, and make decisions, request transactions, and so on, based on the multiple data feeds instead of a single data feed.

The system 100 may also optionally include one or more blockchains (not shown) which can be accessed by elements on the network 110 to record executed transactions on the blockchain. For example, the data feeds 131 may include data about exchange rates between various cryptocurrencies which have transaction ledgers recorded on various blockchains. The client device 120, by accessing the local version 141 on the feed handler server 140, may be able to see information regarding all the data feeds 131 in real-time without significant delay due to the characteristics of the local version 141 and the feed handler server 140 as noted above. Subsequently a user may be able to use the client device 120, e.g., via the interface 125, to execute transactions to exchange these various cryptocurrencies. Upon completion of a transaction, the feed handler server 140 or some other entity may submit transactions to the corresponding blockchains to effect the completion of the transaction. The blockchains may be public blockchains. A public blockchain network may include a plurality of nodes that cooperate to verify transactions and generate new blocks (which may record transaction information regarding cryptocurrencies). In some implementations of a blockchain, the generation of a new block may also be referred to as a mining process. The blockchains may support smart contracts, which are set of code instructions that are executable when one or more conditions are met. When triggered, the set of code instructions may be executed by a computer such as a virtual machine of the blockchain. Here, a computer may be a single operation unit in a conventional sense (e.g., a single personal computer) or may be a set of distributed computing devices that cooperate to execute the code instructions (e.g., a virtual machine or a distributed computing system). Examples of such public blockchain platforms include BITCOIN, ETHEREUM, EOS, NEO, CARDANO, STELLER, etc.

### Example Feed Handler Server

FIG. 2 is a block diagram illustrating the components the feed handler server 140 of FIG. 1, in accordance with an embodiment. In the embodiment shown in FIG. 2, the feed handler server 140 includes a high speed memory 210 with a remote feed cache 215, an inbound list 220, and an outbound list 225. The feed handler server 140 further comprises a lean networking interface controller (NIC) 230, a direct memory access (DMA) module 240, a feed decrypter 245, an integer conversion engine 250, a list modifier 255, and a UI generator 260. The functions of the feed handler server 140 may be distributed among different components in a different manner than described. Also, in various embodiments, the feed handler server 140 may include, different, fewer, and/or additional components.

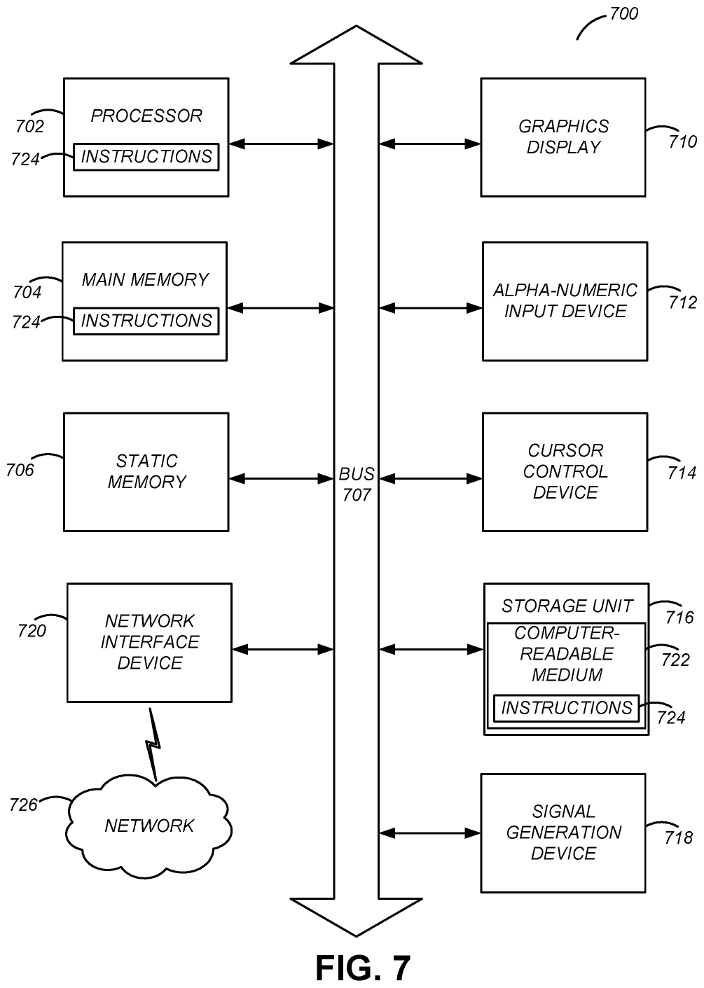

The high speed memory 210 may function similarly to the main memory 604 in FIG. 7 and may be selected for low latency characteristics and high bandwidth throughput. The high speed memory 210 may comprise multiple memory modules arranged in a multi-channel configuration. In addition, the high speed memory 210 may comprise memory across multiple computing devices. The high speed memory 210 may store the remote feed cache 215, as well as the local version 141 of the data feeds 131, which may be represented using multiple separate lists, such as an inbound list 220 for inbound transactions, and an outbound list 225 for outbound transactions, as illustrated.

The remote feed cache 215 stores a temporary copy of any updates received for the data feeds 131 from the remote data feed servers 130. As the updates are processed by the feed handler server 140, they are purged from the remote feed cache 215.

The inbound list 220 stores entries from the data feeds 131 that indicate inbound transactions. These are transactions which indicate a particular transaction flow direction, which indicates who initiated the transaction, and who the transaction is directed towards. The transaction flow direction of the inbound transactions is opposite to the transactions which are stored in the outbound list 225. In one embodiment, the inbound transactions are buy orders for a security, such as an open request to purchase a cryptocurrency in exchange for another cryptocurrency, listed at a specific price and unit quantity.

The outbound list 225 stores entries from the data feeds 131 that indicate outbound transactions. As noted with the inbound list 220, the outbound transactions have an opposite transaction flow direction from the inbound transactions. In one embodiment, the inbound transactions are sell orders for a security, such as an open order to for the sale of a cryptocurrency in exchange for another cryptocurrency, listed at a specific price and unit quantity.

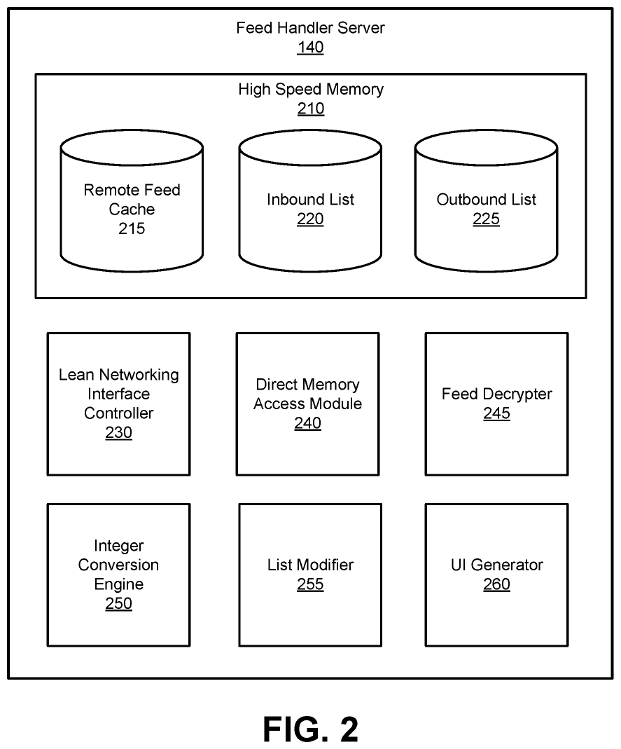

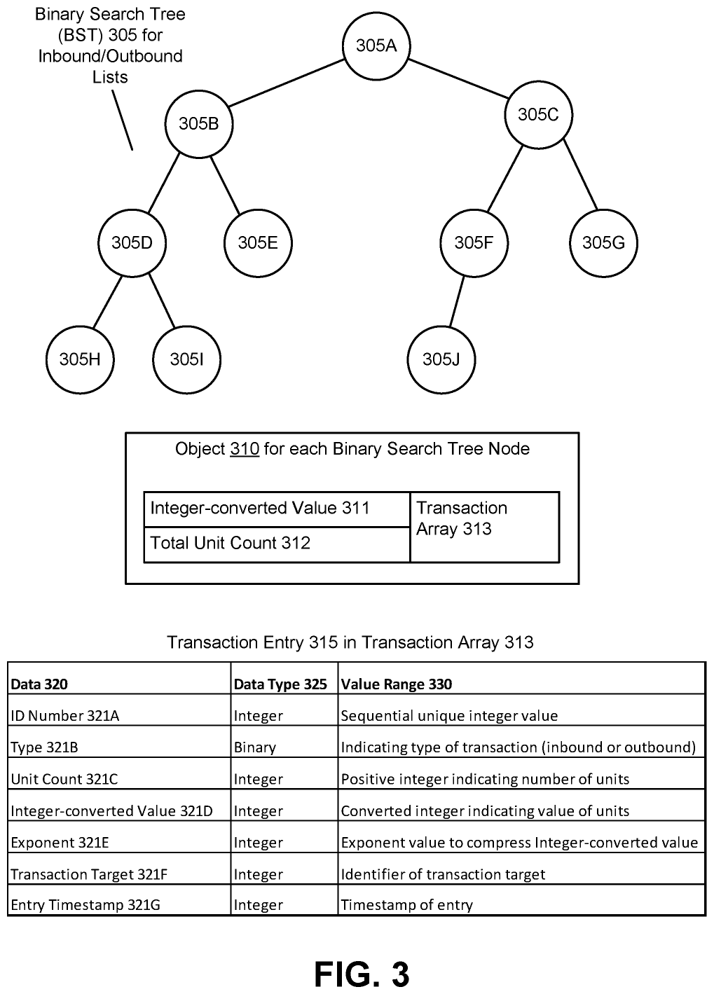

As described in further detail below with regards to FIGS. 3 and 4, the inbound list 220 and the outbound list 230 may be structured in a manner which reduces the time required to add, remove, and/or modify entries within each list, while keeping the entries in the list sorted by various characteristics, such as a timestamp. In one embodiment, the inbound list 220 and the outbound list 230 may be stored as a binary search tree, as illustrated in FIG. 3.

Each entry of either the inbound list 220 or the outbound list 230 may include an entry indicating a value for a transaction that indicates a ratio or other combination (e.g., average, weighted average, difference, product) between two underlying components. This value may, for example, indicate the price of an exchange rate between two currencies. Alternatively, as noted above, this value may indicate some other ratio between two measurements or values. As this value may change dramatically based on changes of the underlying components, storage of this value may take up a large amount of space. For example, a difference between two underlying components A and B may fluctuate from a range of 100 times to one million times. In such a case, the storage requirements for the ratio between A and B would require enough space to store a range of values that accommodate the entire range of differences between A and B, e.g., up to 10 million. This value cannot simply be scaled by removing significant digits as the range of the value is large. For example, removing more than 3 significant digits from the number may cause the number to be registered as zero when the value is near 100. However, this consumes significant memory space, and in the case where the data feed 131 is updated very frequently, can cause the load processing server 140 to run out of memory space. Instead, as described below, a modifier is applied to the value that changes dynamically based on the differences between the underlying components that are used to compute the value. This can reduce the memory requirements to store this value and therefore decrease the memory footprint of the inbound list 220 and outbound list 225.

Although two lists 220 and 225 are shown here, in other embodiments the load processing server 140 maintains additional lists based on the type of underlying data being represented in the lists. For example, in the case where the lists indicate currency exchange rates, the load processing server 140 may maintain an inbound and outbound list for each currency pair combination being observed or for which data is received from the data feed 131.

The lean networking interface controller (NIC) 230 is a network interface controller that uses a modified networking protocol to reduce communications latency between the feed handler server 140 and the remote data feed servers 130. In one embodiment, the lean NIC 230 utilizes microwave or other wireless communication to communicate with the remote data feed serves 130 in order to reduce latency. The lean NIC 230 may be coupled to a microwave transmitter/receiver (e.g., a parabolic dish antenna) in order to transmit and receive microwave signals. In one embodiment the lean NIC 230 also utilizes a lean version of standard networking protocols to communicate with the remote data feed servers 130. The lean version of the standard networking protocol, such as TCP/IP, may remove certain features of that protocol, such as acknowledgements (ACKs), handshake protocols, and so on, in order to further reduce latency caused by the overhead created by the requirements of the standard networking protocol. Once the information regarding the updates to the data feed 131 is received by the lean NIC 230 from the remote data feed servers 130, the lean NIC 230 may transmit this information to the direct memory access (DMA) module 240 for temporary storage in the remote feed cache 215.

The DMA module 240 provides direct access to the high speed memory 210, bypassing the memory management systems of the operating system executing on the feed handler server 140 (and also bypassing the use of the central processing unit (CPU) to read and write to memory). Typically, an operating system (OS) includes various memory management systems, such as virtual memory management, memory-protection systems (e.g., to prevent buffer overflows), and so on. These increase the overhead and processing times for reading and writing to memory. Instead, the DMA module 240 may be a customized component within the memory management system of the OS, a special module within the kernel of the OS, a device driver, or some other component which allows direct access to the physical memory, e.g., the high speed memory 210.

The feed decrypter 245 may optionally be used to decrypt data received from the data feed 131 or perform an initial authentication with the remote data feed servers 130 prior to establishing an initial session to receive the data feeds 131. The updates to the data feeds 131 as received by the feed handler server 140 may be encrypted to prevent unauthorized entities from accessing the information in the data feeds 131, as they may contain sensitive or proprietary information. The feed decrypter 245 may thus decrypt the updates using standard decryption processes, such as public-key cryptography. The feed decrypter 245 may decrypt the data inline before it is written to the high speed memory 210 and after it is received by the lean NIC 230, or it may decrypt the data after it has been written to the high speed memory 210, e.g., when it is in the remote feed cache 215.

The integer conversion engine 250 converts some of the values in the data entries received from the updates of the data feed 131 from floating point or larger memory footprint formats to an integer data type with a smaller memory footprint. As noted, the updates received from the data feed 131 may include values that are based on ratios that can change by orders of magnitude over time. This necessitates that larger memory regions be allocated to store these values. Therefore, data compression of these values is desirable. In order to reduce the space needed to store these values, the integer conversion engine 250 may compute an exponent value that is based on a ratio of the underlying components used to generate the value. In one embodiment, the exponent is generated using the following algorithm:

Exponent=min(8, max(0,4−integer(log₁₀(ratio(unit value of component A,unit value of component B) (1)

Therefore, in order to generate the exponent, the integer conversion engine 250 determines the unit value of the underlying components that are used to generate the original value received from the data feed 131. The unit value is the value of a single unit of each of the underlying components. In the case where the original value indicates an exchange rate, the underlying components are the currencies used to generate the exchange rate, and the unit values are the values of a single unit of each of the currencies. These unit values may be computed in view of a third currency, such as a fiat currency (e.g., USD) or other stable currency. Thus, in the case, the “ratio” as noted above in equation (1) is the value of one unit of the first currency (component A) in view of the third currency, divided by the value of one unit of the second currency (component B) in view of the third currency. Alternatively, the third currency is not used and the ratio may be the current market or historical exchange rate between the first and second currencies. The market rate may be based on the last executed market order for the exchange between the first and second currencies. A logarithmic base 10 operation is performed on the computed ratio value, and it is then converted into an integer (using rounding, floor, or ceiling operations). The integer conversion engine 250 further determines a difference between this resultant value and the value 4, and subsequently determines the maximum value between this difference result and the value zero. Finally, the integer conversion engine 250 determines the minimum between the value 8 and the result from the previous minimum determination. The result from the maximum determination is the exponent.

The exponent value is used to modify the original value by multiplying the original value by 10\hat{ }exponent (i.e., shifting the decimal point of the original value by the exponent value), and further rounding the result to an integer to generate an integer-converted value. This operation reduces the size of the original value, while allowing for a sufficient minimum resolution if the integer-converted value were converted back to the original value. In the case of the currency exchange, this minimum resolution is the tick size. The tick size is the minimum price movement for the currency. As the conversion to the integer-converted value is dynamic, and is based on current differences between the two underlying currencies, the integer-converted value will have the sufficient resolution such that the tick size can always be below a certain threshold, e.g., 1/100^{th} of one of the currencies represented in the exchange rate of the original value.

Furthermore, in the case where the underlying components are different currencies, the exchange of the two currencies can occur in two different directions of transaction flows (the first currency for the second, or the second currency for the first). In such a case, two different ratios may be determined, one for each direction, and two different exponent values may be generated. After computing the integer-converted values, the integer conversion engine 250 transmits the integer-converted value to the list modifier 255.

The integer conversion engine 250 may periodically recompute the exponent value based on updated data (e.g., updated exchange rates) and generate the integer-converted values based on the new exponent. When an update of the exponent value occurs, the integer conversion engine 250 may reconvert all the existing integer-converted values in the inbound list 220 and the outbound list 225 using the new exponent value, may instruct the list modifier 255 to save the new exponent values for each integer-converted value within each entry in the list, or may include a separate list or hash table indicating the exponent values for ranges of integer-converted values (e.g., ranges indicating durations of time).

The list modifier 255 stores the integer-converted value within the local version 141 of the data feed 131. In the example illustrated in FIG. 2, the local version 141 is represented by the inbound list 220 or outbound list 225, with each list storing the integer-converted values for one transaction flow direction. However, in other cases, the list modifier 255 may also store the values in a different list depending on the type of data being processed. In the case where the entry in the update from the date feed entry 131 does not correspond to an existing entry within the local version 141, the list modifier 255 adds a new entry into the local version 141. However, in the case where the entry from the data feed 131 updates an existing entry, the list modifier 255 will look up the existing entry by an identifier provided in the entry from the data feed 131 and update the existing entry with the new data from the data feed 131, including any new integer-converted value.

In some cases, the updated entry from the data feed 131 indicates that an existing entry in the local version 141 should be removed. In such a case, the list modifier 255 removes the entry from the local version 141 in accordance with a provided identifier. Furthermore, in the case where the transactions represent orders, such as orders for a currency exchange, the updated entries from the data feed 131 may indicate that an order was partially or fully filled. In such a case, the list modifier 255 may remove or modify an existing transaction in the local version 141 corresponding to the filled order according to an identifier of the order provided by the update from the data feed 131.

Although some of the examples above were described with regards to currency exchange, the same process may apply to other scenarios where the value received from a data feed or other data source varies greatly by orders of magnitude and thus can be converted to a smaller and more space efficient integer value rather than a larger value or a floating point value, which requires a larger memory footprint. In these scenarios, the “ratio” in equation (1) shown above may be the ratio between the underlying components of the original value as measured over one unit of time. Thus, for example, if the ratio is network throughput per number of unique user sessions in a local network, the unit value of the underlying components may be the network throughput per second (the unit time) and the number of unique user sessions logged per second.

The UI generator 260 generates a graphical user interface that presents the data feeds 131 to a user, e.g., a user of the client device 120, using the local version of the data feeds 131, e.g., the inbound list 220 and the outbound list 225. Although the UI generator 260 is shown to be at the feed handler server 140, in other embodiments it may be at the client device 120 instead. The UI generator 260 may present various levels of detail of the data present in the inbound list 220 and the outbound list 225. In one embodiment, the UI generator 260 presents a top level view which shows the highest ranked values from the inbound list 220 and the outbound list 225. In other embodiments, the UI generator 260 may present additional data, such as a list of all the entries present in the inbound list 220 and the outbound list 225. When presenting the information from the lists, the UI generator 260 may convert the integer-converted values in the lists back to the original values (or an approximation of the original values) using the corresponding exponent values. Thus, a user sees the original values (or an approximation thereof) rather than the integer value. Using the information presented in the user interface, a user may be able to execute transactions and perform other activities. The UI generator 260 may update the user interface in real time as new data is updated from the data feeds 131 to the inbound list 220 and outbound list 225. These updates may include additions, deletions, and updates to the lists.

### Example Data Structure for Inbound and Outbound Lists

FIG. 3 is a block diagram illustrating an example of an optimized computer data structure in which the data feed entries from remote data feed are stored, in accordance with an embodiment. As illustrated, the optimized computer data structure is a binary search tree (BST) 305. A BST is a type of data structure that stores data entries, and keeps the keys of each data entry in a sorted order, such that the lookup, insertion, and deletion of each entry in the BST takes, on average, time proportional to a logarithm of the size of the BST (e.g., O (log n)). In the case of the storage of the local version 141 of the data feeds 131 that includes the inbound list 220 and the outbound list 225, two BSTs may be used, one for each list. The entries in each list, which as described above, include the integer-converted values, are stored in the BST as nodes. The nodes in the BSTs may be keyed according to the integer-converted values of each corresponding entry. Each node may be linked to a left and right sub-tree, with the nodes in one of the sub-trees having integer-converted values of lower rank, and the nodes in the other sub-tree having integer-converted values of higher rank, compared to the integer-converted values of the node. Nodes, or entries, may be added or removed recursively. Nodes, or entries, may be looked up or updated by comparing each node with the value to be looked up.

In one embodiment, instead of including each entry in one of the lists 220 or 225 in each node, each node of the BST 305 includes an object, such as object 310, that indicates the integer-converted value 311, optionally a total unit count 312, and a transaction array 313. The transaction array 313 stores a list of transaction entries, such as transaction entry 315 (referred to generally as transaction entry 315 or transaction entries 315). Each transaction entry 315 corresponds to an entry received from the data feeds 131. Each transaction entry 315 in the transaction array 312 has an integer-converted value, such as integer-converted value 321D, that matches the integer-converted value 311 of the object 310. Therefore, each object 310 includes all entries from the data feeds 131 that have the same matching integer-converted values. Furthermore, the transaction entries 315 in the transaction array 313 may be sorted by the entry timestamp 321G of each transaction entry 315, with the entry having the oldest entry timestamp 321G being sorted highest. Therefore, new entries are added to the back of the array, with oldest entries, which are sorted highest due to their oldest timestamp, at the front of the array.

In either of the above implementations, each transaction entry or node may also be associated with a unique identifier, such as ID number 321A, which may be an integer value. This may be provided in the data feeds 131. A separate hash table may be stored in each of the inbound list 220 and outbound list 225 which hashes upon this unique identifier, to further improve lookup of each entry, as well as their deletion and modification, as the updates from the data feeds 131 may be identified by the same identifiers. Thus, if an update from the data feeds 131 references an existing entry using a unique identifier, the hash table can be used to quickly locate that entry and to modify or delete it.

Furthermore, in one embodiment, the BST 305 described here may be a Red-Black BST, which further balances the nodes in the tree such that the number of nodes in the sub-trees of each node are approximately equal after insertions and deletions of nodes.

In addition to the ID number 321A, integer-converted value 321D, and entry timestamp 321G, each transaction entry 315 may include other values. These may include the type 321B, unit count 321C, the exponent 321E, and the transaction target 321F. The type 321B indicates the transaction flow direction, and may optionally be included in the transaction entry 315. The exponent 321E, as described previously, represents the exponent to which the integer-converted value 321D is modified by. The unit count 321C indicates a number of units of an underlying component for which the creator of the transaction wishes to transact for, in exchange for another underlying component. These component may be any units of a currency, security, or other asset. The optional transaction target 321F identifies the underlying components of the transaction. Thus, for example, if the creator of the transaction wishes to buy 50 units of a first currency using a second currency, the transaction target 321F would identify the two currencies, while the unit count 321C indicates the 50 units. A sum of all the unit counts 321C in all the transaction entries 315 in an object 310 may be stored as the total unit count 312.

Additional details regarding the process of insertion, deletion, and modification of entries in the BST 305 when receiving updates from the data feeds 131 is described with reference to FIG. 4.

Example Process for Local Version Update from Remote Data Feed

FIG. 4 is a block and flow diagram illustrating an example conversion of data received from the data feed to increase data compression, in accordance with an embodiment.

As previously shown, the integer conversion engine 220 converts values received from entries of the data feeds 131 received from the remote data feed servers 120 into integer-converted values. An example of this process with exemplary values is illustrated in FIG. 4.

Initially, an entry 410 is received as an update to a data feed 131 from the remote data feed server 120. This transaction 410 may correspond to an entry in the data feed 131. The transaction 410 may indicate an identifier number 415A, unit count 415B, and timestamp 415C. These may be similar to the components of the previously described transaction entry 315, i.e., the ID number 321A, unit count 321C, and entry timestamp 321G, respectively.

In addition, the transaction 410 may include the transaction type 415D, which indicates the type of the transaction. The transaction type may indicate whether a transaction entry is to be added, removed/cancelled, modified/amended, or whether the request indicated in the transaction entry was fulfilled (either fully or partially). Depending upon the type of transaction, the entry 410 received from the remote data feed server 120 may not indicate all elements indicated here.

The entry 410 may also indicate a value 415E, and optionally a transaction target 416F. The value 415E, as described above, is converted to the integer-converted value. The transaction target 416F is similar to the transaction target 321F described above. In some embodiments, the transaction target 416F is not specified in the entry 410 but is indicated by the data feed 131 from which the entry 410 is received. Here, the symbols shown in the transaction target 416F indicates an exchange between a currency A and a currency B. The value 415E is 285.614, and as described above, indicates a ratio between two underlying components, which are the two currencies A and B in this example (defined in terms of a third currency). Here, the value 415E is not only represented in floating point format, which uses more memory to store compared to a smaller integer, but also has 6 digits, therefore requiring storage sufficient to store values of at least six digits.

The integer conversion engine 250 receives the entry 410, and converts the value 415E in the entry 415E by computing 420 the ratio between the unit values indicated by the transaction target 416F. In this case, the ratio is the same as the value 415E, and is the ratio between the first currency A and the second currency B. As noted, in other cases, the ratio may represent the exchange rate of the latest fulfilled transaction. Using this ratio value, the equation (1) is used to compute the exponent, which in this case is the integer value 2. This exponent is used by the integer conversion engine 250 to convert 425 the value 415E into an integer-converted value by multiplying the value 415E by 10\hat{ }2, or 100. This results in the integer-converted value 28571. The integer conversion engine 250 stores 430 this value in the corresponding locally stored BST.

### Example Flow

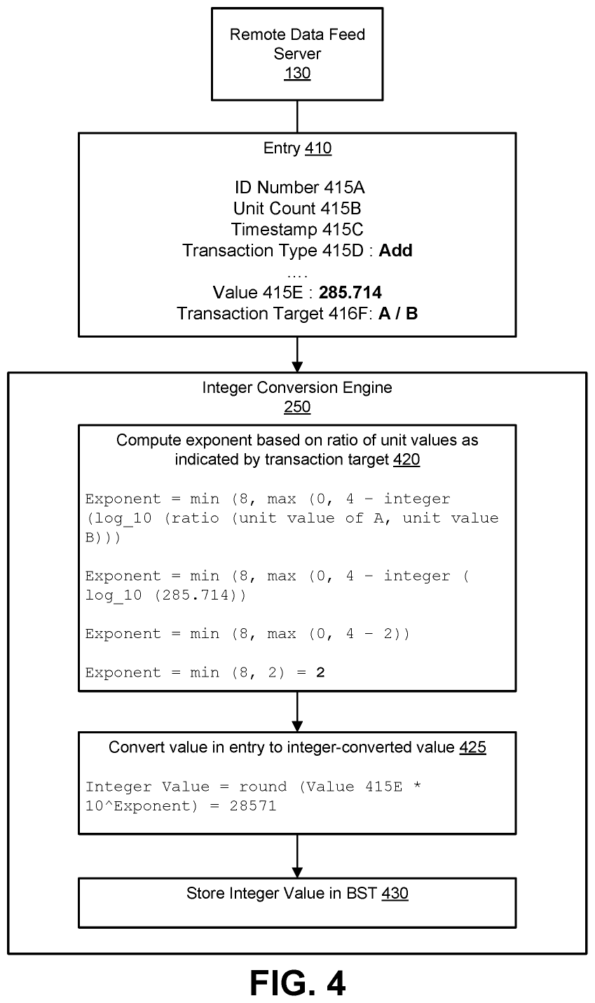

FIG. 5 is a flowchart illustrating an example process for data compression of data received from a remote data feed, in accordance with an embodiment. In one embodiment, the process 500 may be executed by the feed handler server 140.

The feed handler server 140 receives 510 a transaction entry from a data feed, such as the data feed 131. The transaction entry indicates at least a floating-point value amount. The data feed indicates a transaction target. These may be the value 415E and transaction target 416F, respectively. The data feed 131 may be received from a remote data feed server 130.

The feed handler server 140 converts 520 the floating-point value amount in the transaction entry to an integer value amount based on a ratio between two underlying components indicated by the transaction target. Thus, the transaction target may indicate two underlying components, such as two different currencies. The ratio is therefore calculated based on these two currencies. In one embodiment, the floating-point value is converted into an integer value amount by generating an exponent based on the ratio, such as in equation (1) above.

The feed handler server 140 stores 530 the integer value amount in a corresponding entry in the locally stored priority queue. This may correspond to a transaction entry in a BST, such as the transaction entry 315 in the BST 305. The entry may be created if one does not yet exist, or an existing entry may be modified with the newly updated integer value amount.

### Example Blockchain Architecture

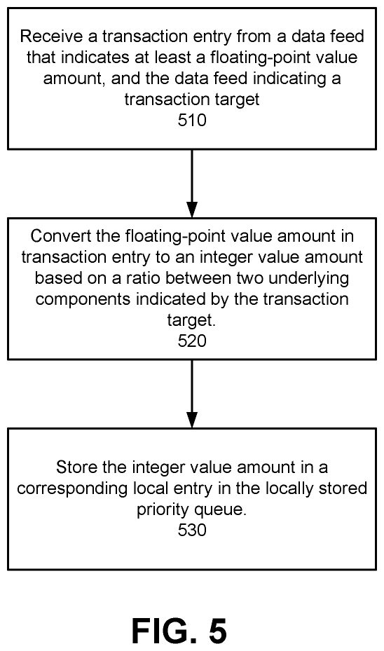

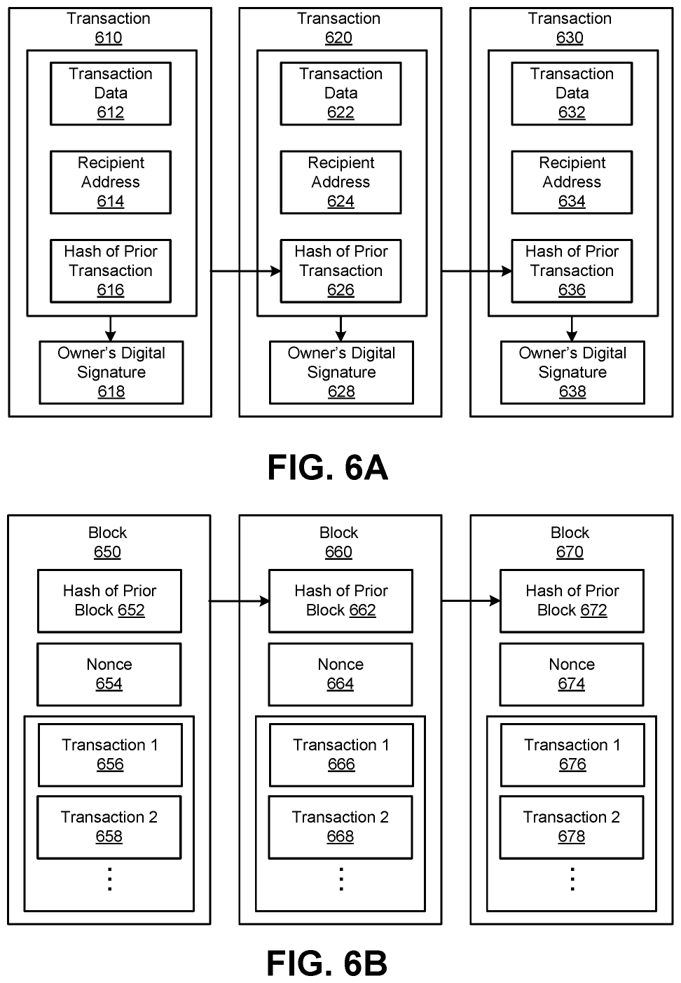

FIG. 6A is a block diagram illustrating a chain of transactions broadcasted and recorded on a blockchain, in accordance with an embodiment. As noted above, the underlying components used to generate the ratio for the conversion to the integer-converted value may be two different cryptocurrencies. A cryptocurrency is a currency that has a ledger that is stored in a decentralized blockchain. Therefore, when a user requests the execution of a transaction using, e.g., the feed handler server 140, and the transactions are based on cryptocurrencies, the resulting execution of that transaction results in the changing of ownership of varying amounts of these cryptocurrencies. The change of ownership can be recorded in the blockchain ledger. The blockchain records transactions that have occurred using the cryptocurrency in one or more blockchain units stored in the blockchain, but does not require a central authority to verify that the transactions are legitimate. Instead, the blockchain is generated via the cooperation of multiple nodes, or computing systems.

The distributed blockchain network may include a plurality of nodes. Each node is a user or a server that participates in the blockchain network. In a completely public blockchain, any participant may become a node of the blockchain. The nodes collectively may be used as a distributed computing system that serves as a virtual machine of the blockchain. In some embodiments, the virtual machine or a distributed computing system may be simply referred to as a computer. Any users of a public blockchain may broadcast transactions for the nodes of the blockchain to record. Each user's digital wallet is associated with a cryptographic private key that is used to sign transactions and prove the ownership of a blockchain unit.

The ownership of a blockchain unit may be traced through a chain of transactions. In FIG. 6A, a chain of transactions may include a first transaction 610, a second transaction 620, and a third transaction 630, etc. Each of the transactions in the chain may have a fairly similar structure. While each transaction is linked to a prior transaction in FIG. 6A, the transaction does not need to be recorded on consecutive blocks on the blockchain. For example, the block recording the transaction 610 and the block recording the transaction 620 may be separated by hundreds or even thousands of blocks. The traceback of the prior block is tracked by the hash of the prior block that is recorded by the current block.

Referring to one of the transactions in FIG. 6A, for illustration, the transaction 620 may be referred to as a current transaction. Transaction 610 may be a prior transaction and transaction 630 may be referred to a subsequent transaction. Each transaction includes a transaction data 622, a recipient address 624, a hash of the prior transaction 626, and the current transaction's owner's digital signature 628. The transaction data 622 records the substance of the current transaction 620. For example, the transaction data 622 may specify a transfer of a quantity of a blockchain unit (e.g., an electronic coin, a blockchain token, a BCDR, etc.). In some embodiments, the transaction data 622 may include code instructions of a smart contract.

The recipient address 624 is a version of the public key that corresponds to the private key of the digital wallet of the recipient. In one embodiment, the recipient address 624 is the public key itself. In another embodiment, the recipient address 624 an encoded version of the public key through one or more functions such as some deterministic functions. For example, the generation of the recipient address 624 from the public key may include hashing the public key, adding a checksum, adding one or more prefixes or suffixes, and encoding the resultant bits. The recipient address 624 may be a unique identifier of the digital wallet of the recipient on the blockchain.

The hash of the prior transaction 626 is the hash of the entire transaction data of the prior transaction 610. Likewise, the hash of the prior transaction 636 is the hash of the entire transaction data of the transaction 620. The hashing of the prior transaction 610 may be performed using a hashing algorithm such as a secure hash algorithm (SHA) or a message digest algorithm (MD). In some embodiments, the owner corresponding to the current transaction 620 may also use the public key of the owner to generate the hash. The hash of prior transaction 626 provides a traceback of the prior transaction 610 and also maintains the data integrity of the prior transaction 610.

In generating a current transaction 620, the digital wallet of the current owner of the blockchain unit uses its private key to encrypt the combination of the transaction data 622, the recipient address 624, and the hash of prior transaction 626 to generate the owner's digital signature 628. To generate the current transaction 620, the current owner specifies a recipient by including the recipient address 624 in the digital signature 628 of the current transaction 620. The subsequent owner of the blockchain unit is fixed by the recipient address 624. In other words, the subsequent owner that generates the digital signature 638 in the subsequent block 630 is fixed by the recipients address 624 specified by the current transaction 620. To verify the validity of the current transaction 620, any nodes in the blockchain network may trace back to the prior transaction 610 (by tracing the hash of prior transaction 626) and locate the recipient address 614. The recipient address 614 corresponds to the public key of the digital signature 628. Hence, the nodes in the blockchain network may use the public key to verify the digital signature 628.

The transfer of ownership of a blockchain unit may continue by the owner of the blockchain unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the mining process.

FIG. 6B is a block diagram illustrating a connection of multiple blocks in a blockchain, in accordance with an embodiment. Each block of a blockchain, except the very first block which may be referred to as the genesis block, may have a similar structure. The blocks 650, 660, and 660 may each include a hash of the prior blockchain 652, a nonce 654, and a plurality of transactions (e.g., a first transaction 656, a second transaction 658, etc.). Each transaction may have the structure shown in FIG. 6A.

A new block may be generated through a mining process. For a public blockchain, any nodes in the blockchain system may participate in the mining process. The generation of the hash of the prior block may be conducted through a trial and error process. The entire data of the prior block (or a version of the prior block such as a simplified version) may be hashed using the nonce as a part of the input. The blockchain may require a certain format in the hash of prior block in order for the new block to be recognized by the nodes as valid. For example, in one embodiment, the hash of the prior block needs to start with a certain number of zeroes in the hash. Other criteria of the hash of the prior block may also be used, depending on the implementation of the blockchain.

By way of example, in generating the hash of prior block 662, a node which participates in the mining process may randomly combine a version of the prior block 650 with a random nonce (i.e., a random value) to generate a hash. The generated hash is somewhat a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries a combination with another different random nonce to generate another hash. The process is repeated by different nodes in the blockchain network until one of the nodes find a hash that satisfies the criteria. The nonce that is used to generate the satisfactory hash is the nonce 664. The node that first generates the satisfactory hash 662 may also select what transactions that are broadcasted to the blockchain network is to be included in the block 660. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., a gas) for having the transaction recorded. After the transactions are selected and the data of the block 660 is fixed, the nodes in the blockchain network repeat the trial and error process to generate the hash of prior block 672 by trying different nonces.

In some cases different nodes may select different transactions to include in a subsequent blocks, and may compete with each other to find the proper nonce for that set of transactions that has a generated hash that satisfies the criteria. Therefore, there may be a situation where multiple satisfactory hashes are generated for blocks that contain different transactions. This creates a fork in the blockchain. Future blocks may be hashed based on the data in either block of this fork. However, in practice, in order to avoid adding blocks to multiple forks, the nodes may reach consensus by selecting the fork that has the block with an earlier timestamp, or use some other criteria, in order to select the primary fork from which to hash further blocks.

New blocks may be continued to be generated through the mining process. A transaction of a blockchain unit (e.g., an electronic coin, a blockchain token, a BCDR, etc.) is complete when the broadcasted transaction is recorded in a block. In some embodiment, the transaction is considered settled when the transaction is multi-verified. A transaction is multi-verified when there are multiple subsequent blocks generated and linked to the block that records the transaction.

In some embodiments, some of the transactions 656, 658, 666, 668, 676, 678, etc. may include one or more smart contracts. The code instructions of the smart contracts are recorded may be recorded in the block and are often immutable. When conditions are met, the code instructions of the smart contract are triggered. The code instructions may cause a computer (e.g., a virtual machine of the blockchain) to carry out some actions such as generating a blockchain unit and broadcasting a transaction documenting the generation to the blockchain network for recordation.

### Computing Machine Architecture

FIG. 7 is a block diagram illustrating components of an example computing machine that is capable of reading instructions from a computer-readable medium and execute them in a processor (or controller). A computer described herein may include a single computing machine shown in FIG. 7, a virtual machine, a distributed computing system that includes multiples nodes of computing machines shown in FIG. 7, or any other suitable arrangement of computing devices. The computer described herein may be used by any of the elements described in the previous figures to execute the described functions.

By way of example, FIG. 7 shows a diagrammatic representation of a computing machine in the example form of a computer system 700 within which instructions 724 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 7 may correspond to any software, hardware, or combined components shown in the figures above. While FIG. 7 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 724 that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors (generally, processor 702) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a computer-readable medium 722 on which is stored instructions 724 embodying any one or more of the methodologies or functions described herein. The instructions 724 may also reside, completely or at least partially, within the main memory 704 or within the processor 702 (e.g., within a processor's cache memory) during execution thereof by the computer system 700, the main memory 704 and the processor 702 also constituting computer-readable media. The instructions 724 may be transmitted or received over a network 726 via the network interface device 720.

While computer-readable medium 722 is shown in an example embodiment to be a single medium, the term “computer-readable medium” should be taken to include a single medium or multiple media (e.g., a centralized or distributed database, or associated caches and servers) able to store instructions (e.g., instructions 724). The computer-readable medium may include any medium that is capable of storing instructions (e.g., instructions 724) for execution by the machine and that cause the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### Additional Configuration Considerations

Certain embodiments are described herein as including logic or a number of components, engines, modules, or mechanisms, for example, as illustrated in FIG. 2. Engines may constitute either software modules (e.g., code embodied on a computer-readable medium) or hardware modules. A hardware engine is a tangible unit capable of performing certain operations and may be configured or arranged in a certain manner. In example embodiments, one or more computer systems (e.g., a standalone, client or server computer system) or one or more hardware engines of a computer system (e.g., a processor or a group of processors) may be configured by software (e.g., an application or application portion) as a hardware engine that operates to perform certain operations as described herein.

In various embodiments, a hardware engine may be implemented mechanically or electronically. For example, a hardware engine may comprise dedicated circuitry or logic that is permanently configured (e.g., as a special-purpose processor, such as a field programmable gate array (FPGA) or an application-specific integrated circuit (ASIC)) to perform certain operations. A hardware engine may also comprise programmable logic or circuitry (e.g., as encompassed within a general-purpose processor or another programmable processor) that is temporarily configured by software to perform certain operations. It will be appreciated that the decision to implement a hardware engine mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 702, that are temporarily configured (e.g., by software) or permanently configured to perform the relevant operations. Whether temporarily or permanently configured, such processors may constitute processor-implemented engines that operate to perform one or more operations or functions. The engines referred to herein may, in some example embodiments, comprise processor-implemented engines.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Upon reading this disclosure, those of skill in the art will appreciate still additional alternative structural and functional designs for a similar system or process through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. A system comprising:
a feed handler configured to:
receive a transaction entry from a data feed, the transaction entry indicating at least a floating-point value amount, the data feed associated with a transaction target;
modify a locally stored priority queue based on the transaction entry by:
converting the floating-point value amount in the transaction entry to an integer value amount based on a ratio between two underlying components indicated by the transaction target; and
storing the integer value amount in a corresponding entry in the locally stored priority queue.

2. The system of claim 1, wherein the data feed is received from a remote data feed server, and wherein the feed handler communicates with the remote feed server using a lean version of Transmission Control Protocol/Internet Protocol (TCP/IP), the lean TCP/IP protocol avoiding a latency due to a TCP/IP handshake.

3. The system of claim 1, further comprising a client device connected to the feed handler via a network and configured to: present a graphical user interface to a user of the client device, the interface including one or more web pages presenting data from the locally stored priority queue.

4. The system of claim 1, wherein the locally stored priority queue is a binary search tree (BST) that is indexed according to the integer value amount of each entry in the BST.

5. The system of claim 4, further comprising a hash table that has as a key a transaction entry identifier and as a value a reference to the corresponding transaction entry in the BST.

6. The system of claim 1, wherein the ratio is a ratio between a first unit value of a first underlying component of the two underlying components, and a second unit value of a second underlying component of the two underlying components.

7. The system of claim 1, wherein the floating point value is converted to the integer value by:
computing an exponent value based on the ratio;
shifting a decimal position of the floating point value by the exponent to generate a shifted floating point value; and
generating the integer value from the shifted floating point value by rounding the shifted floating point value to an integer.

8. The system of claim 1, wherein the floating-point value amount is a relation between a first component and a second component, the floating-point value indicating a requested amount of the second component to exchange for a unit of the first component.

9. The system of claim 8, wherein the exchange, once executed, is recorded on one or more blockchains.

10. The system of claim 1, wherein the feed handler is configured to receive a plurality of transaction entries from a plurality of different data feeds and combine the data from the plurality of transaction entries into a single locally stored priority queue.

11. A computer-implemented method, comprising:
receiving a transaction entry from a data feed, the transaction entry indicating at least a floating-point value amount, the data feed associated with a transaction target;
modifying a locally stored priority queue based on the transaction entry by:
converting the floating-point value amount in transaction entry to an integer value amount based on a ratio between two underlying components indicated by the transaction target; and
storing the integer value amount in a corresponding entry in the locally stored priority queue.

12. The method of claim 11, wherein the data feed is received from a remote data feed server, and wherein the feed handler communicates with the remote feed server using a lean version of Transmission Control Protocol/Internet Protocol (TCP/IP), the lean TCP/IP protocol avoiding a latency due to a TCP/IP handshake.

13. The method of claim 11, further comprising a client device connected to the feed handler via a network and configured to: present a graphical user interface to a user of the client device, the interface including one or more web pages presenting data from the locally stored priority queue.

14. The method of claim 11, wherein the locally stored priority queue is a binary search tree (BST) that is indexed according to the integer value amount of each entry in the BST.

15. The method of claim 14, further comprising a hash table that has as a key a transaction entry identifier and as a value a reference to the corresponding transaction entry in the BST.

16. The method of claim 11, wherein the ratio is a ratio between a first unit value of a first underlying component of the two underlying components, and a second unit value of a second underlying component of the two underlying components.

17. The method of claim 11, wherein the floating point value is converted to the integer value by:
computing an exponent value based on the ratio;
shifting a decimal position of the floating point value by the exponent to generate a shifted floating point value; and
generating the integer value from the shifted floating point value by rounding the shifted floating point value to an integer.

18. The method of claim 11, wherein the floating-point value amount is a relation between a first component and a second component, the floating-point value indicating a requested amount of the second component to exchange for a unit of the first component.

19. The method of claim 18, wherein the exchange, once executed, is recorded on one or more blockchains.

20. The method of claim 11, further comprising receiving a plurality of transaction entries from a plurality of different data feeds; and combining the data from the plurality of transaction entries into a single locally stored priority queue.
